(19) United States
(12) Patent Application Publication
(10) Pub. No.: US 2002/0167396 A1
(43) Pub. Date: Nov. 14, 2002

(54) Pager with both POCSAG and FLEX systems

(76) Inventor: Tsung-Hsin Chang, Hsi-Chih (TW)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/852,236

(22) Filed: May 10, 2001

(51) Int. Cl. H04Q 7/14

(52) U.S. Cl. 340/7.43

(57) ABSTRACT

A pager with both POCSAG and FLEX systems comprising a POCSAG decoder IC and a FLEX decoder IC; the FLEX decoder IC is connected to a microprocessor and the POCSAG decoder IC is built inside the microprocessor, a transistor based circuitry controlled by the microprocessor is between the 4 level IF receiver IC and decoder IC's, the signals and data are transmitted in 4 levels. The pager with both POCSAG and FLEX systems that can be used by different customers under different paging systems, manufacturers and retailers can also reduce the stocking cost for having two different pagers.

### BACKGROUND OF THE INVENTION

I. Field of the Invention

This invention relates generally to a pager with both POCSAG (Post Office Code Standardization Advisory Group) and FLEX systems and, more specifically, to a pager with both POCSAG and FLEX systems that can be used by different customers under different paging systems, manufacturers and retailers can also reduce the stocking cost.

II. Description of the Prior Art

Heretofore, it is known pager has two different systems, one is European standard POCSAG system, and the other one is FLEX system of Motorola. Manufacturers and retailers must have pagers for two systems to meet different customers with different requirements, thus increase the stocking cost.

The POCSAG system has 2 levels and three different speeds: 512, 1200 and 2400 bps; the FLEX system has 4 levels with speeds of 1600, 3200 and 6400 bps. The characteristics of pagers are: small physical size, power saving and single direction, therefore it is essential to keep those characters while combining the two systems, following are major considerations:

1. The power saving method of the POCSAG system is to apply capcode in different Frames to control RF (Radio Frequency) board to receive or not to receive signals. On the other hand, the power saving method of the FLEX system is according to system's Collapse and Frame to control RF board to receive or not to receive signals. The POCSAG system is a non-synchronous system; the FLEX system is a synchronous system. Therefore the two systems must not have conflict condition.

2. The POCSAG system has 2 levels and the FLEX system has 4 levels, the common receiver they share must based on 4 Levels; when the POCSAG system functions, it needs only 2 levels, the other set of data can be ignored.

3. The capcode of the POCSAG system has two million combinations, while the FLEX system has more than four billion combinations, therefore the capcode applied must available for two systems.

### SUMMARY OF THE INVENTION

It is therefore a primary object of the invention to provide a pager with both POCSAG and FLEX systems that can be used by different customers under different paging systems, manufacturers and retailers can also reduce the stocking cost for having two different pagers.

In order to achieve the objective set forth, a pager with both POCSAG and FLEX systems in accordance with the present invention comprises a POCSAG decoder IC and a FLEX decoder IC; the FLEX decoder IC is connected to a microprocessor and the POCSAG decoder IC is built inside the microprocessor, a transistor based circuitry controlled by the microprocessor is between the 4 level IF receiver IC and decoder IC's, the signals and data are transmitted in 4 levels.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a block diagram of the present invention;

FIG. 2 is a circuit diagram (I) of a further embodiment of the present invention;

FIG. 3 is a circuit diagram (II) of a further embodiment of the present invention.

### DESCRIPTION OF THE PREFERRED EMBODIMENT

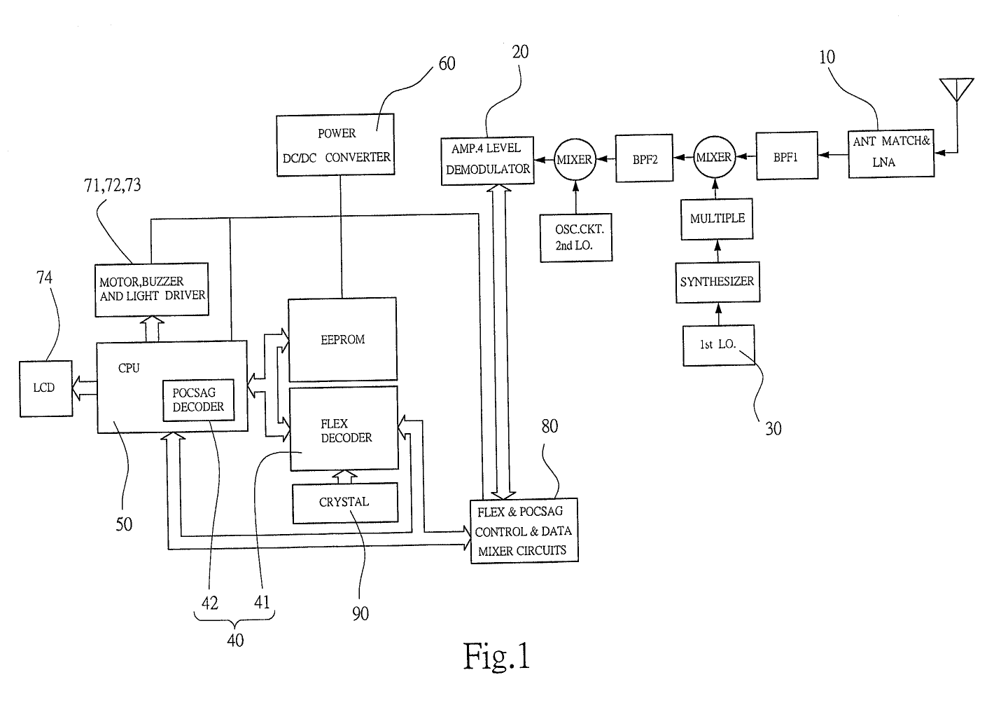

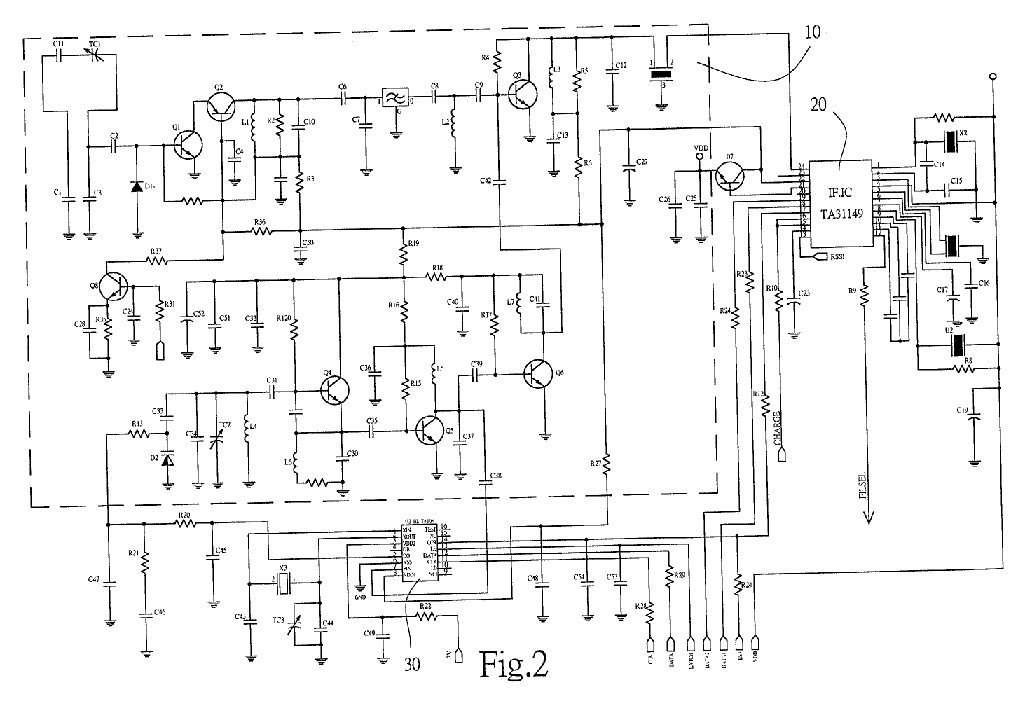

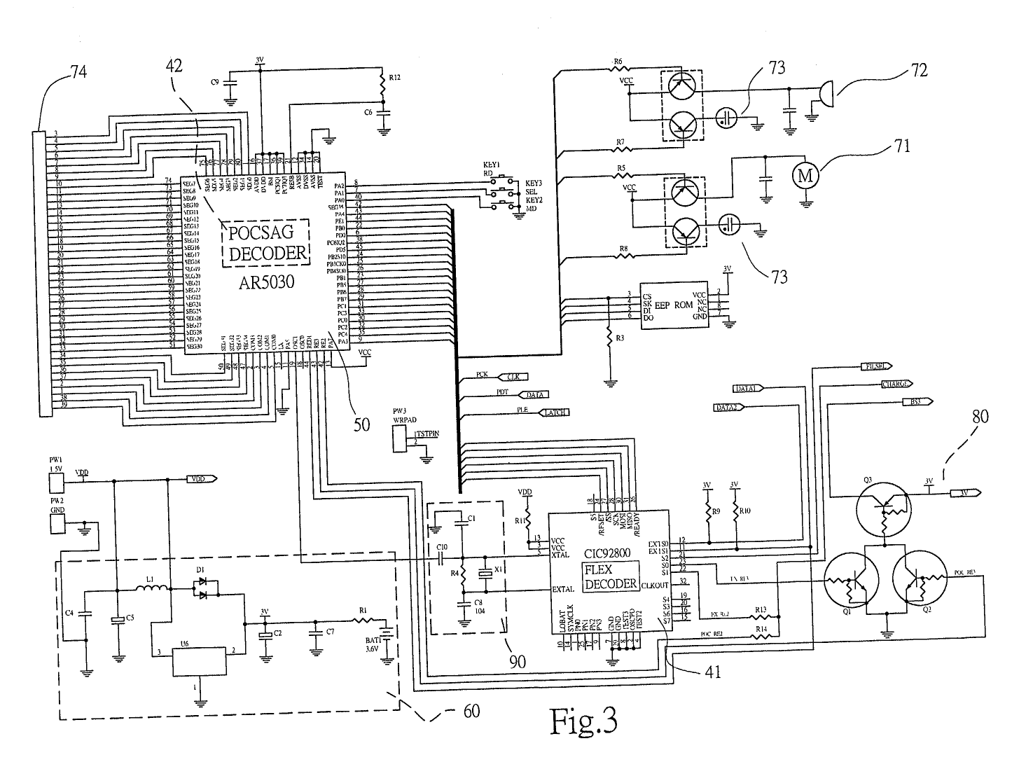

Referring to FIG. 1 to FIG. 3, the present invention is composed of a wireless RF signal receiver circuitry 10, a 4 level IF receiver IC 20, a LO synthesizer IC 30, a decoder 40, a microprocessor 50 and a power supply 60. When the wireless RF signal receiver circuitry 10 receives a signal, the signal is mixed with another signal from LO synthesizer 30; it is converted to digital signal by the 4 level IF receiver IC 20. This signal then is amplified, demodulated and decoded by the decoder 40, finally processed by the microprocessor 50 to send the proper control signal to activate motor 71, buzzer 72 light 73 and/or LCD display 74.

The decoder 40 consists of a FLEX decoder IC 41 and a POCSAG decoder IC 42, the FLEX decoder IC 41 is connected to the microprocessor 50, the POCSAG decoder IC 42 is built inside the microprocessor 50. A control transistor circuitry 80 controlled by the microprocessor 50 is between the 4 level IF receiver IC 20 and the decoder 40, all the signals transmitted are in 4 level format.

Based on above description, the wireless RF signal receiver circuitry 10 of present invention chooses FSK FM IF IC TA31149 as the 4 level IF receiver IC 20 to send out 4 level data signals.

Pagers are required to be small in physical size, therefore the decoder 40 consists of the microprocessor 50 (CPU, AR5030) with built-in POSCAG decoder 42 and FLEX decoder IC 41 (CIC92800). The microprocessor 50 and the FLEX decoder IC 41 share a common oscillator 90 that is a crystal with 76.8 k Hz.

Based on above description, the POSCAG decoder 42 inside the microprocessor 50 and the FLEX decoder IC 41 control the received signals by the wireless RF signal receiver circuitry 10. Both decode IC's have RE3 (RF Enable), RE2 (Quick Charge) control pins to control IF IC. A transistor control circuitry 80 consists of transistor Q1, Q2 and Q3 allow RF signals coexist in both POCSAG system and FLEX system without conflict. Q1 and Q2 are NPN type transistors, a resistor on the base forms a open collector circuit and function as a NAND operation, Q3 works as a power supply to offer 3V power to the pins controlled by Q1, Q2.

The two control pins RE3 of the both decoders, when RE3 is Hi, the collector of Q3 also outputs Hi to for Q1 or Q2 conduct, when both RE3 outputs Lo, the collector of Q3 is off without output. RE2 control pin is shared with the RE2 of FLEX decoder IC 41 and the RE2 of POCSAG decoder IC 42, therefore 4 level IF receiver IC 20 needs only 1.1 V to function, so a very simple resistor connection circuit will do: R13, R14 are connected in series to RE2 of the both decoder IC's, when only the RE2 of POCSAG decoder IC 42 outputs Hi that causes R13 and R14 also generate a Hi signal with 1.5V. When RE2 of the POCSAG decoder IC 42 outputs Lo, R13 and R14 are also Lo, therefore Hi, and Lo control signals can be generated. If RE2 of FLEX system activates, the RE2 of POCSAG is off and outputs Lo that will get same as RE2 of POCSAG; this is how to share RE2.

The data transmission path of POCSAG decoder IC 42 and FLEX decoder IC 41 is a one and two pin respectively. The POCSAG system has 2 levels and the FLEX system has 4 levels, therefore the pin of DATA 1 connected to both decoders, the pin of DATA 2 is only connected to the FLEX decoder IC 41. The output of the 4 level IF receiver IC 20 are of open collector circuit, therefore DATA 1 and DATA 2 pins have the pull-up resistors connected to power to generate the proper voltage level for the decoders. When POCSAG system activates, the FLEX decoder has to be off, DATA 1 is available only when POCSAG decoder functions. When FLEX system activates, the POCSAG decoder is off, DATA 1 and DATA 2 signals can be received by the FLEX decoder; this is how to share the data path.

The capcode of the POCSAG system and the FLEX system are different, therefore one has to understand the theory and setup method of the decoders in order of implement software properly, the capecode of POCSAG system has 7 digits and 10 digits for the FLEX system. Software has to differentiates the different systems and output the different displays for users to do the proper input.

While a preferred embodiment of the invention has been shown and described in detail, it will be readily understood and appreciated that numerous omissions, changes and additions may be made without departing from the spirit and scope of the invention.

What is claimed is:

1. A pager with both POCSAG and FLEX systems comprising:
a wireless RF signal receiver circuitry;
a 4 level IF receiver IC;
a LO synthesizer IC;
a microprocessor;
a decoder,
wherein said decoder having a POCSAG decoder IC being built inside said microprocessor and a FLEX decoder IC being connected to said microprocessor; a control transistor circuitry controlled by said microprocessor is disposed between said mid-range frequency signal converter IC and said decoder, all the signals transmitted are in 4 level format; and while said wireless RF signal receiver circuitry receives a signal, said signal is mixed with another signal from said LO synthesizer and then is converted to digital signal by said 4 level IF receiver IC; the signal then is amplified, demodulated and decoded by said decoder, finally processed by said microprocessor to send the proper control signal to activate motor, buzzer, light and/or LCD display.

2. The pager with both POCSAG and FLEX systems recited in claim 1, wherein said microprocessor connecting and controlling a transistor control circuitry, said transistor control circuitry compromising transistor Q1, Q2 and Q3, Q1 and Q2 are NPN type transistors with a resistor on the base form a open collector circuit and function as a NAND operation, the collector of Q3 connecting to the control pin of said 4 level IF receiver IC, the base of Q3 connecting to the collector of Q1 and Q2 offering 3V power to Q1 and Q2.

3. The pager with both POCSAG and FLEX systems recited in claim 1, wherein said 4 level IF receiver IC is TA31149.
